(19) United States
(12) Patent Application Publication
(10) Pub. No.: US 2003/0031030 A1
(43) Pub. Date: Feb. 13, 2003

(54) Directional indicator light for boat

(75) Inventor: Norman E. Simms, Barnegat, NJ (US)

Correspondence Address: OSTROLENK FABER GERB & SOFFEN, 1180 AVENUE OF THE AMERICAS, NEW YORK, NY, 100368403

(73) Assignee: Chicago Miniature Lamp, Inc.

(21) Appl. No.: 10/215,488

(22) Filed: Aug. 8, 2002

Related U.S. Application Data
(60) Provisional application No. 60/310,936, filed on Aug. 8, 2001.

(51) Int. Cl. F21V 7/04

(52) U.S. Cl. 362/555

(57) ABSTRACT

A directional indicator light for a marine vehicle has red and green LEDs positioned on port and starboard sides of the marine vehicle, respectively. The indicator includes a lens for focusing and directing the light provided by the LEDs. The indicator can be sealed to prevent exposure to the marine environment. The LEDs are arranged in arrays and connected in parallel, to prevent the failure of one LED from extinguishing an entire directional indicator. The directional indicator has a lower profile and consumes less power than conventional marine directional indicators.

### RELATED APPLICATION

This application is based on and claims benefit of U.S. Provisional Application Serial No. 60/310,936, filed Aug. 8, 2001, entitled DIRECTIONAL INDICATOR LIGHT FOR BOAT, to which a claim of priority is hereby made.

### FIELD OF THE INVENTION

This invention relates to navigation lights and more specifically to a navigation lamp that indicates travel direction.

### BACKGROUND OF THE INVENTION

The invention concerns a navigation lamp employing light emitting diode lights for use on a boat for indicating its direction of travel. Typically, there is a navigation lamp or light mounted on the bow and/or stern of the boat with a red lamp on the port side and a green lamp on the starboard side so that the direction of travel of the boat is indicated to other boats.

Presently, the navigation lamp is an incandescent lamp with one bulb. Typically, an incandescent lamp light source generates a yellow/white color. The indicator light is provided with appropriately placed color tinted lenses for indicating green on the starboard side and red on the port side. The incandescent lamp is housed in a housing which is sealed closed to protect the wiring, the bulb and contacts from moisture. The lens is a two piece molded tinted lens that is sealed to the lamp housing. There is typically a metal cover on the lamp that conducts heat generated by the bulb away from the lamp. Since this lamp usually has only a single bulb light source, if the bulb burns out, the entire directional signal indication is lost until the bulb is replaced. Further, the two lamps (red and green source) consume substantial electrical power and requires considerable volume, while averaging about two inches in height.

### SUMMARY OF THE INVENTION

According to the present invention, there is provided a single directional indicator for a boat that is composed of sets of two or more LEDs having different color outputs. The LEDs are separated into red and green color sections in a single assembly and are arranged to show a boat direction. The LED arrangement is provided with a common lens to cover the LEDs, and the LEDs are configured on a printed circuit board for power control and physical support. The LEDs use less power than incandescent bulbs. Moreover, the directional indicator light composed of LEDs continues to work even should one or more LEDs in either set bum out. In addition, the LEDs are smaller in size and produce much less heat than the incandescent bulb of the prior art.

### BRIEF DESCRIPTION OF THE DRAWINGS

The present invention is described below in detail with reference to the drawings, in which:

FIG. 1 is a schematic perspective of a unitary navigation lamp according to the present invention;

FIG. 2 is a side cross-section of the present invention;

FIG. 3 is an exploded perspective view; and

FIG. 4 is a circuit diagram according to the present invention;

FIG. 5a is a plan view of another embodiment of the present invention; and

FIG. 5b is a side view of the embodiment of FIG. 5a.

### DESCRIPTION OF THE PREFERRED EMBODIMENTS

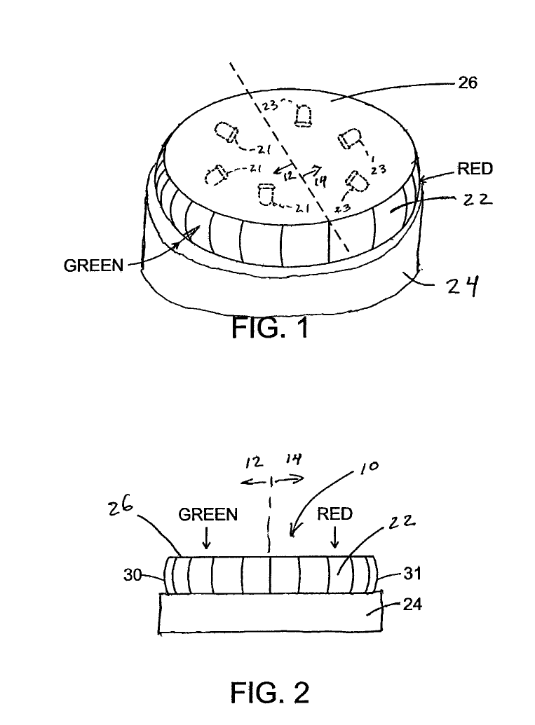

Referring now to FIGS. 1 and 2, there is shown a single unitary housing 10 that emits a green light to the starboard side 12 of a vehicle on which it is mounted and a red light to the port side 14 of the vehicle. According to the invention, the starboard light output and the port light output is generated by a dedicated light source in the form of at least one, and preferably several, solid state light emitting diodes (LED) of the selected color, that is, red and green. The LEDs are arranged in essentially semicircular arrays, one array of red LEDs 23 and another of green LEDs 21. The two arrays of red and green LEDs 23, 21 are positioned to produce red light on the side of the navigation lamp facing the port side of the vehicle, and green light towards the starboard side. The LEDs 21, 23 are positioned on a printed circuit board (not shown) and each LED is aimed to provide the required radially outward directed output in the selected color. A lens 22 over a base 24 surrounds the LEDs and has a top portion 26 over the lens 22. Top portion 26, lens 22 and base 24 can be sealed together to prevent moisture or other environmental contaminants from entering the navigation lamp.

The circuit board holding the LEDs is connected to a power source (not shown) through a switch (not shown) to turn the lamp on and off. The combined electrical current drawn by all of the LEDs is typically expected to be approximately 20% of the electrical current drawn by a standard incandescent bulb generating the equivalent amount of illumination. In addition, heat generated by the lamp is expected to be greatly reduced in comparison with a standard incandescent bulb. The reduced heat output permits a smaller profile lamp housing to be used, since not as much heat needs to be conducted away from the lamp. That is, the housing need not be designed with a large heat conduction capacity that would result in a bulkier size.

According to the present invention, the LEDs 21, 23 or the molded lens 22 may be colored to provide the appropriate light color output. The molded lens 22 around the lamp is optically designed for maximum illumination output of the light provided from the LEDs. Preferably, as shown in FIG. 2, lens 22 consists of respective semicircular lens 30, 31 on each side of the lamp giving the entire combined lens array a circular shape. Each of the semicircular lenses 30, 31 is a compound lens for maximizing illumination output. For example, each may be a Fresnel lens, which concentrates the output in desired directions. Base 24 can be opaque and mount to a boat on which the lamp is to be used.

LEDs 21, 23 can be connected according to the circuit as shown in FIG. 4. The configuration of this circuit is such that if one of the LEDs 21, 23 should be extinguished or bum out for any reason, other LEDs 21, 23 remain illuminated, without loss of indication. This can be achieved by connecting the LEDs 21, 23 in parallel as in FIG. 4. The LEDs 21, 23 are shown grouped together so that if one of LEDs 21, 23 becomes inoperative, other LEDs 21, 23 do not become inoperative. LEDs 21, 23 can be grouped in any manner desired, as long as they are mainly connected in parallel to permit continued output of a red or green indication even if a given LED fails.

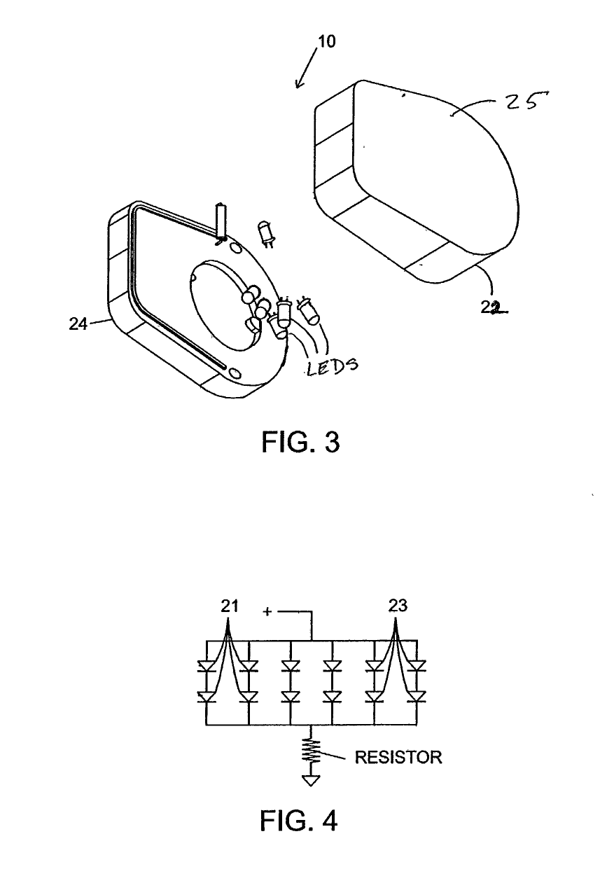

Referring now to FIG. 3, another embodiment of the invention, in which a top cover 25 includes the lens 22 is shown. Top cover 25 need not be of metal, since LEDs 21, 23 are cool light sources and bulb heat need not be conducted away. Because LEDs 20 are small in size and diameter, the height of the lens 22 in top cover 25 is not dictated by the diameter of an incandescent bulb, but rather can be set as small as desired for aesthetics and ease of mounting. The lens 22 should have a sufficient width and height so that a semicircular band of light can be emitted through the lens 22 to be visible across an appropriate distance and provide an indication of navigational direction.

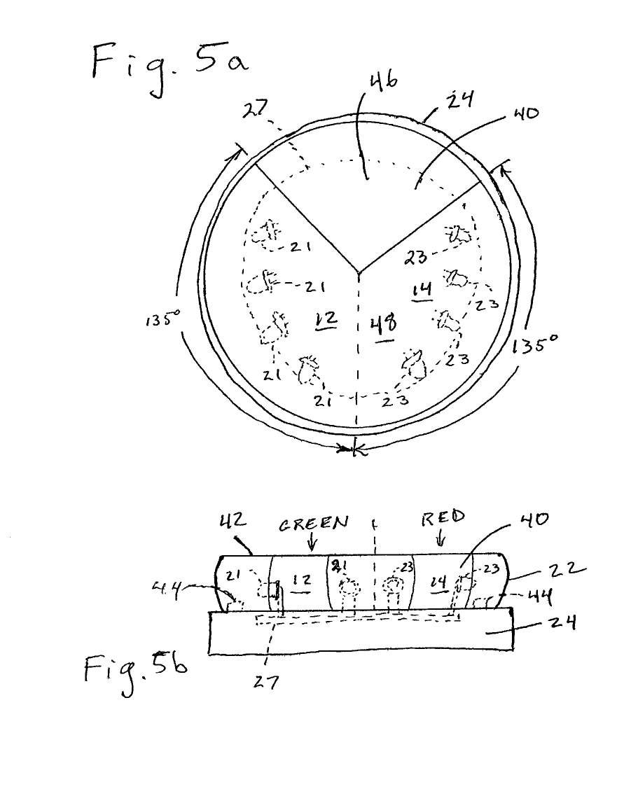

Referring now to FIGS. 5a and 5b, another embodiment of the present invention is shown. The embodiment includes a molded outer case 40 that has an outer edge serving as the lens 22. Lens 22 has a convex contour with respect to case 40 that assists in dispensing light in desired directions. Green and red light output portions 12 and 14 respectively put out directed light over an angle of 135° each. A remaining 90° portion 46 of case 40 has internal deflectors or reflectors (not shown) to direct internally oriented light back through lens 22 to increase light output. A top portion 48 of case 40 is opaque or translucent to decrease the amount of light that can escape from the top of the directional indicator. By providing portions 46 and 48 with reduced output or reflected light properties, rearward and upward directional light indication is prevented.

Case 40 is molded as one piece with portions 46 and 48 arranged to reflect or decrease light output as desired. In addition, lens 22 is molded into case 40, along with Fresnel elements (not shown) to increase light output and provide colimnated or directed light. Case 40 is generally molded in a cup shape with portions 46, 48 having desired light reflective or light attenuating characteristics, respectively. The molding process includes lens 22 and Fresnel elements so that case 40 forms a complete outer housing for the directional indicator according to the present invention.

Case 40 also has orienting features 44 provided in the molding process, such as recesses or bosses. Orienting features 44 cooperate with reciprocal features on base 40 to properly orient the directional indicator with respect to base 24. Base 24 is installed on the vehicle with an appropriate orientation to permit case 40 to be easily oriented on base 24 in the proper direction through orienting features 44.

Base 24 includes a circuit board 27 and wiring to supply power to the directional indicator and LEDs 21, 23. LEDs 21, 23 are mounted on circuit board 27, which is mounted on base 24 and connected to a power source to provide appropriate power output for desired indicator illumination. Base 24 is mounted to the vehicle, and case 40 is mounted to base 24 so that the circuit and LEDs 21, 23 are covered and enclosed by case 40. Base 24 and case 40 can be sealed to each other and to the vehicle to avoid contamination by exposure to hostile environments. The assembly of base 24 and case 40 provide a simplified two piece construction for the directional indicator, with a low height profile and small footprint. For example, the entire assembly can be about 3/4 inch in height, while having a diameter of about 2-1/4 inches. Base 24 can also include support portions for holding the circuit board 27 in a fixed position.

The directional indicator is typically powered with a 12V DC source, however, any type of power configuration can be used, as long as the LED circuit can convert the supply power to operate the LEDs. The indicator can be operated with an ON/OFF switch through an operator console for ease of use. In addition, the indicator can be used on a number of types of vehicles such as power boats, personal watercraft, and the like, because of its simplified design and small profile.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A directional indicator light for a marine vehicle, comprising:
a housing having an inner chamber and coupled to the marine vehicle;
a lens structure on a wall of the housing and communicating light between the chamber and an exterior of the housing;
a first LED having a first color and positioned in the chamber to provide a first directional information to the exterior of the housing through the lens structure; and
a second LED having a second color and positioned in the chamber to provide a second directional information to the exterior of the housing through the lens structure.

2. The directional indicator according to claim 1, wherein the first color is red and the second color is green.

3. The directional indicator according to claim 1, wherein the first LED is positioned on a starboard of the marine vehicle, and the second LED is positioned on a port side of the marine vehicle.

4. The directional indicator of claim 1, further comprising a cover sealably attached to the housing to seal the chamber from a marine environment.

5. The directional indicator of claim 1, wherein the lens structure includes a Fresnel lens.

6. The directional indicator according to claim 1, wherein the first and second LED are connected in parallel.

7. The directional indicator according to claim 1, wherein the lens structure further comprises a first and second semicircular lens positioned adjacent the first and second LED, respectively.

8. The directional indicator according to claim 7, wherein the first and second semicircular lenses are Fresnel lenses.

9. The directional indicator according to claim 7, wherein the first and second color are white, and the first and second semicircular lenses have a red and a green color, respectively.

10. The directional indicator according to claim 1, further comprising a base attached to the marine vehicle between the housing and the marine vehicle for mounting the housing on the marine vehicle.

11. A directional indicator light for a marine vehicle, comprising:
a housing have an inner chamber and coupled to the marine vehicle;
a lens structure on a wall of the housing and communicating light between the chamber and an exterior of the housing;
a plurality of LEDs in the chamber and operable to provide a light output through the lens structure when powered; and
the lens structure having a first and second color tint, such that light emitted through the lens structure is colored according to the first and second color tint.
